(19) United States
(12) Patent Application Publication
(10) Pub. No.: US 2004/0214701 A1
(43) Pub. Date: Oct. 28, 2004

(54) Elastomer-coated roller and method for drawing a sleeve onto a roller core

(75) Inventor: Wolfgang Wirtz, Kerpen (DE)

Correspondence Address: GRIFFIN & SZIPL, PC, SUITE PH-1, 2300 NINTH STREET, SOUTH, ARLINGTON, VA, 22204, US

(73) Assignee: Felix Boettcher GmbH & Co. KG, Koeln (DE)

(21) Appl. No.: 10/762,567

(22) Filed: Jan. 23, 2004

(30) Foreign Application Priority Data
Jan. 29, 2003 (DE) 10303386.6

(51) Int. Cl. F16C 13/00; B23P 17/00

(52) U.S. Cl. 492/49; 29/895.2; 29/895.23

(57) ABSTRACT

A roller particularly suitable for applying varnishes onto sheet metal plates comprises a hollow roller core (10). The hollow roller core (10) is connected with pins (16,18) via coupling elements (20,22) arranged in the interior of the roller core (10). With respect to the front faces (26), the coupling elements (20,22) are arranged so as to be inwardly offset. Air exit openings are provided in a border region (28) of the roller core (10). A channel forming element (34) is provided to connect the air exit openings (32) with a roller interior (44). Through the channel forming element (34), a channel (36) is formed connected with the roller interior (44) via the opening (42) provided in the coupling element (20).

### BACKGROUND OF THE INVENTION

1. Field of the Invention

The invention relates to a roller, particularly for applying varnishes onto sheet metal plates and the like. Such sheet metal plates are used, for example, for the manufacture of cans. Further, the invention relates to a method for drawing a sleeve or a bushing onto an air mandrel.

Rollers, for instance, comprise a hollow roller core which is typically cylindrical. On the roller core made as an aluminum diecasting, for example, a coating of, e.g., an elastomeric material is applied. This coating is subject to wear and therefore, it has to be regularly renewed. To this end, the entire roller has to be transported to a treatment plant for being treated. For treating the roller, the coating is removed by grinding or peeling, for example, and replaced by a new coating. This is extremely time-consuming and cost-intensive, particularly because of the necessary transport of heavy rollers.

2. Description of Related Art

From German Patent DE 31 39 494, it is known, for example, to provide a pressure bushing particularly made of elastomeric material instead of a coating of the roller core. The sleeve or bushing has a surface suitable for the application of varnishes and is drawn onto the roller core. After the pressure bushing has reached its wear limit, it can be exchanged relatively easily. To this end, the roller core comprises radially extending bores and is connected with a compressed air generator. The air flows into the roller interior and exits to the outside via the radial bores or air exit openings. Thereby, an air film is produced. This allows for sliding on or pulling off the sleeve with respect to the roller core. The use of bushings eliminates the necessity of transporting the entire roller for the renewal of the coating.

In rollers with a hollow roller core, the latter is connected with two pins provided at the front faces of the roller core. The pins serving to receive the roller core are connected with the roller core via coupling elements which are disc-shaped, for example. Thus, the coupling elements configured as round plates or discs are arranged within the roller core and bear the pins. The coupling elements that are disc-shaped, for example, may be arranged so as to be offset inward relative to the roller front face so that the pins protrude beyond the front faces of the roller core as slightly as possible. This, however, goes along with the disadvantage that no air exit openings can be provided in a border region of the roller core since this border region is arranged outside the coupling elements. To be able to slide sleeves onto the roller core, however, air exit openings are required in the border region since the sleeves have a slightly smaller diameter than the roller core. This results in that no sleeves can be used when such roller cores with inwardly offset coupling elements are used. Thus, it is required to provide a corresponding coating on the roller cores so that the roller has to be transported and the coating has to be removed in a troublesome manner when it has to be renewed. Particularly when colors are applied or sheet metal plates are varnished, for cans, for example, it is required to provide a great number of rollers of, e.g., different widths or different profilings for applying the varnish.

From U.S. patent application U.S. Pat. No. 6,389,965, a mandrel extension for rollers as a mounting aid for sliding on a bushing-shaped reinforcing layer onto a compressible layer arranged on a roller is known. The mandrel extension comprises radially extending escape openings to facilitate sliding the bushing-shaped reinforcing layer onto the compressible layer.

### SUMMARY OF THE INVENTION

It is an object of the invention to provide a roller, particularly a varnishing roller, which can be treated in a simple manner when the coating is worn.

This object is solved, according to the invention, by a roller with the features of claim 1.

The inventive roller with inwardly offset coupling elements serving to connect the pins with the roller core is configured such that a sleeve can be put onto the roller core. Particularly, the roller may be a varnishing roller. To this end, air exit openings are provided in a border region of the roller core. According to the invention, a channel forming element is created to be able to connect these air exit openings with a source of compressed air in a simpler manner and thus to produce an air film at a top surface of the roller core in the region of the front face.

The channel forming element provided forms a junction channel between the air exit openings and the roller interior. Thus, it is possible to supply compressed air within the roller core, i.e., to the roller interior, which then produces an air film via the junction channel and the air exit openings in the border region of the roller core in the same way as rollers with coupling elements provided outside at the front faces do. Thereby, it is also possible to laterally slide a sleeve, e.g., a cylindrical or tubular part of rubber, polyurethane or the like onto the roller core with a minimum of friction when the roller is provided with inwardly offset coupling elements. In order to exchange the sleeve, the sleeve can be placed onto the roller core with radial clearance. Thus, it is possible to draw up sleeves onto rollers with inwardly offset coupling elements because of the provision of a channel forming element according to the invention. This has the advantage that the roller does not have to be transported for being treated, i.e., for renewing the elastomer layer when the elastomer surfaces of the roller are worn or damaged. A troublesome removal of a coating is not required, either. With the roller of the invention, it is rather possible to exchange the sleeve in situ. Particularly when varnishing sheet metal plates, this has the advantage that different sleeves can be simply exchanged so that a single roller can be used for different varnishing processes by simply exchanging the sleeve. Thus, the number of rollers which is very great in the field of varnishing sheet metal plates in particular can be reduced considerably.

The channel forming element is preferably annular and can be inserted into the roller core. The coupling element bearing the pins may be arranged within the channel forming element, for example, so that the channel forming element surrounds the coupling element. For reasons of stability, however, the coupling element is directly connected with the roller core. In this embodiment, the channel forming element is thus arranged outside the coupling element in the border region of the roller core. To guarantee a connection between the air exit openings and the roller interior via the junction channel, the coupling element comprises openings or recesses. They may be through bores or recesses open towards an inner wall of the roller core.

Preferably, the roller core is manufactured as an aluminum diecasting. Preferably, the roller core is cylindrical. The roller core may also be conical, the sleeve to be slid onto the roller core then also being conical at the inside so that a roller core particularly configured as an “air mandrel” with a sleeve slid thereon (varnishing roller) has a cylindrical outer jacket surface.

The coupling element may be formed integrally with the pins. Preferably, however, they are two separate components, the coupling element preferably being also made as an aluminum diecasting and the pin consisting of steel. Then, the pin is connected with the coupling element via a screw connection, the coupling element being able to be welded to the roller core.

The channel forming element according to the invention may form part of the coupling element and thus be formed integrally with the coupling element. Preferably, however, it is a separate annular part with a preferably L-shaped cross section, which is inserted into the roller core in the border region. Preferably, the inserted channel forming element is also an aluminum diecasting and welded to the roller core and/or the coupling element.

Further, the invention relates to a method for drawing up a sleeve onto a roller core converted to an “air mandrel”. Preferably, the roller is a varnishing roller designed in correspondence with the above description. According to the method according to the invention, an air film is formed on the outside of the roller core, the air film being produced by an air stream from the roller interior flowing preferably through a junction channel to air exit openings into the roller core and thus producing an air film in the border region of the roller core. Subsequently, the sleeve that typically has a slightly smaller inner diameter than the outer diameter of the roller core is slid onto the roller core over the border region of the roller core.

### BRIEF DESCRIPTION OF THE DRAWING

Hereinafter, the invention will be explained in detail with respect to a preferred embodiment thereof with reference to the accompanying drawing.

FIG. 1 shows a schematic longitudinal section of a roller according to the invention.

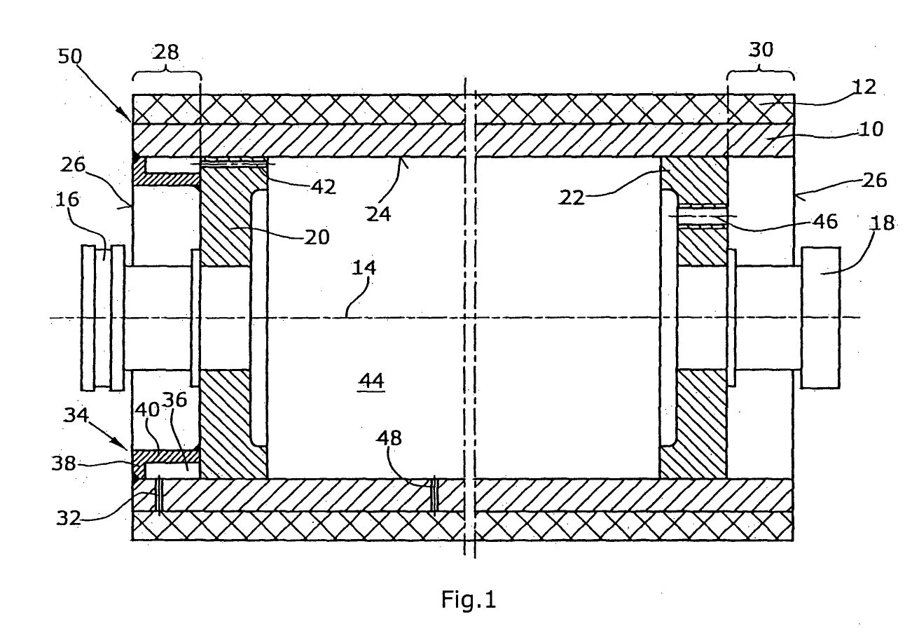

### DETAILED DESCRIPTION OF THE PREFERRED EMBODIMENT OF THE INVENTION

The roller comprises a roller core 10 configured as a hollow cylinder in the illustrated embodiment. The roller core 10 is surrounded by a sleeve 12 also configured as a hollow cylinder. The roller core 10 is an aluminum diecasting. The sleeve 12 onto the outside of which the varnish is applied for being transferred to a sheet metal plate, for example, consists of a carrier bushing (e.g., glass fiber reinforced plastic) and an elastic material that may be multi-layered, if necessary.

Centrically to a rotational axis 14, two pins 16,18 are provided at both sides of the roller to receive the roller in a varnishing machine. By means of the pins 16,18, the roller is supported in the varnishing machine and driven in a rotatory manner via coupling elements. Via coupling elements 20,22 that are disc-shaped or configured as round plates, the pins 16,18 are connected with the roller core 10. To this end, the coupling elements 20,22 also made of aluminum are welded to an inside 24 of the roller core 10. The pins 16,18, which are preferably made of steel or the like for reasons of stability, are screwed into the coupling elements 20,22.

With respect to the front faces 26 of the roller, the coupling elements 20,22 are arranged so as to be inwardly offset. Thereby, a border region 28,30 respectively adjacent to the front faces 26 is created.

In the border region 28, several, preferably at least three and particularly preferably at least six air exit openings 32 are arranged. In the illustrated embodiment, the air exit openings 32 are configured as radial bores and extend through the entire roller core 10. By means of a channel forming element 34 with an L-shaped cross section, a junction channel 36 is formed. Since the channel forming element 34 is annular, the junction channel 36 is annular as well. All air exit openings 32 are connected with the channel 36. Since the channel 36 is annular, no exact adjustment between the air exit openings 32 and the channel 36 is required. The channel forming element 34 has a short leg 38 extending substantially radially outward in the direction of the roller core 10 and a long leg 40 extending substantially in axial direction. Preferably via weld seams, the short leg 38 as well as the long leg 40 are connected with the roller core 10 and the coupling element 20, respectively. An outside of the short leg 38 is substantially arranged in the plane of the front face 26. Thus, the junction channel 36 is formed through the channel forming element 34 as well as the inner wall 24 of the roller core 10.

In the illustrated embodiment, the annular circumferential channel 36 is connected with the roller interior 44 via an opening or recess 42 configured as a bore. Instead of a through bore 42, a differently configured opening such as a notch in axial direction of the coupling element 20 may be arranged to establish a connection between the channel 36 and the roller interior 44.

To be able to generate pressure in the roller interior 44, a connection element 46 is provided in the opposite coupling element 22. In the illustrated embodiment, the connection element 46 is an internally threaded bore for being able to connect a compressed air hose or another coupling element to a compressed air source.

Further, the roller core (“air mandrel”) 10 may comprise further air exit openings 48 being directly connected to the roller interior 44 and extending also in preferably radial direction through the entire roller core 10.

In order to exchange the sleeve 12, the air pressure in the roller interior 44 is increased via the connection element 46. Thereby, air flows through the bore 42 into the channel 36 and from the latter, it flows into the air exit openings 32. Further, air flows through the air exit openings 48. Thereby, an air film is produced between the roller core 10 and the sleeve 12 so that the pressure sleeve 12 can be drawn off the roller core 10 to the left in the drawing. Because of the escaping air and the air film produced thereby, the process of putting or drawing on a new or another sleeve 12 is made easier.

If necessary, an outer edge 50 of the roller core 10 is additionally chamfered to this end.

Although the invention has been described and illustrated with reference to specific illustrative embodiments thereof, it is not intended that the invention be limited to those illustrative embodiments. Those skilled in the art will recognize that variations and modifications can be made without departing from the true scope of the invention as defined by the claims that follow. It is therefore intended to include within the invention all such variations and modifications as fall within the scope of the appended claims and equivalents thereof.

1. A roller, particularly for applying varnishes onto sheet metal plates, comprising
a hollow roller core,
pins for receiving the roller in a printing machine,
coupling elements for connecting the pins with the roller core so that a roller interior is formed,
characterized in that
the coupling elements are arranged so as to be inwardly offset with respect to the roller front faces,
air exit openings are provided in a border region of the roller core outside the coupling elements, and
a channel forming element for forming a junction channel between the air exit openings and the roller interior is provided.

2. The roller of claim 1, characterized in that the channel forming element is inserted into the roller core.

3. The roller of claim 1, characterized in that the channel forming element has a L-shaped cross section so that the junction channel is formed through the channel forming element and an inner wall of the roller core.

4. The roller of claim 1, characterized in that the channel forming element is annular.

5. The roller of claim 1, characterized in that one of the coupling elements comprises at least one opening communicating with the junction channel and the roller interior.

6. The roller of claim 1, characterized in that one of the coupling elements comprises a connection element for the connection with a source of compressed air.

7. The roller of claim 1, comprising a sleeve drawn up onto the roller core (air mandrel).

8. A method for drawing a sleeve onto a roller core of a roller according to claim 1, wherein
an air film is formed between the sleeve and an outside of the roller core, and
the sleeve is slid or drawn onto the roller core at the side of the channel forming element.

9. A method of drawing a sleeve onto a roller core comprising the step of providing a roller according to claim 1.
